(19) United States
(12) Patent Application Publication
(10) Pub. No.: US 2014/0087877 A1
(43) Pub. Date: Mar. 27, 2014

(54) COMPOSITING INTERACTIVE VIDEO GAME GRAPHICS WITH PRE-RECORDED BACKGROUND VIDEO CONTENT

(71) Applicant: Rathish Krishnan, Foster City, CA (US)

(72) Inventor: Rathish Krishnan, Foster City, CA (US)

(73) Assignee: Sony Computer Entertainment Inc., Tokyo (JP)

(21) Appl. No.: 13/629,522

(22) Filed: Sep. 27, 2012

(51) Int. Cl. A63F 13/02

(52) U.S. Cl. 463/33

(57) ABSTRACT

A method for compositing realistic video game graphics for video games is disclosed. The method includes rendering images of interactive game objects based on the current gameplay and virtual game camera parameters such as a pan angle, tilt angle, roll angle, and zoom data. The rendered images constitute the foreground of a game's display, which is superimposed on prerecorded video content. The prerecorded video content constitutes the background of the game display and may include one or more real live videos or animation transformed from a prerecorded panoramic video based on the virtual game camera parameters and the gameplay. The generation and superimposition of the foreground images and background videos can be performed repeatedly using synchronization methods to dynamically reflect the user actions within the virtual game environment.

### TECHNICAL FIELD

This disclosure relates generally to video game graphics and, more particularly, to the technology for constituting video game graphics by dynamically superimposing a foreground image having interactive game objects and a pre-recorded video content.

### DESCRIPTION OF RELATED ART

The approaches described in this section could be pursued, but are not necessarily approaches that have previously been conceived or pursued. Therefore, unless otherwise indicated, it should not be assumed that any of the approaches described in this section qualify as prior art merely by virtue of their inclusion in this section.

There have been steady improvements in visual presentations via graphical user interfaces (GUIs), and in particular, improvements associated with graphical characteristics of video games. Most modem video games provide virtual environments, through which the players can interact with one another or various game objects. The video game developers wish to create realistic gaming environments to enhance the overall game experience. To this end, game environments may include three-dimensional images having non-interactive objects, such as a background, as well as interactive objects such as user avatars or other game artifacts. A Graphics Processing Unit (GPU) can render images of game objects in real time during the play. Several graphics techniques, such as scaling, transformation, texture mapping, lighting modeling, physics-based modeling, collision detection, animation, anti-aliasing, and others can be used to create the visual appearance of the gameplay in real time. However, to improve game graphics and, correspondingly, user experience, better computational resources and complex graphics techniques are needed.

However, computational resources are limited and often not sufficient to create realistic virtual game environments. For example, a GPU may need to create a single frame for a video game every 33 milliseconds, which is a frame rate of 30 frames per second (FPS). High computational demands result in trade-offs associated with rendering images, which may prevent the game graphics from achieving high levels of quality.

To improve the experience of playing video games, some developers may include pre-recorded video fragments that can be shown during certain actions or scenes, for example when a player completes a particular game level. These video fragments can be of a higher quality and can have more realistic graphics than those shown during a regular gameplay. Moreover, the playback of such pre-recorded video fragments may not utilize large computational resources compared to the resources required for real-time rendering of such fragments. However, during the playback of these pre-recorded video fragments, the players may have limited or no control over the game.

Some other video games, such as music-based games, may play real live video over which graphic elements are overlaid. However, these games have a fixed game camera, which means the players may not have any control over the game camera, and thus the displayed video cannot be transformed. Similarly, augmented-reality games may utilize live video captured directly by a video camera connected to a game console, but the game camera cannot be controlled by the players.

Therefore, utilization of pre-recorded video content has been traditionally considered an obstacle to interactivity in video games. Furthermore, to provide high-quality three-dimensional graphics, large computational resources may be needed. As a result, today's game graphics technologies makes it extremely challenging to provide realistic video game graphics of high quality for the interactive games in which players exercise control over the virtual game camera.

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

The present disclosure involves compositing realistic video game graphics for the video games in which the players have control over virtual game cameras, and for games in which the game developer can predict the movement of the virtual game camera. The technology involves rendering images of interactive game objects based on the current gameplay and virtual game camera parameters such as a pan angle, tilt angle, roll angle, and zoom data. The rendered images constitute the foreground of game scene that is displayed, which is then superimposed with pre-recorded video content. The video content constitutes the background of the game scene and refers to a real live video or high definition animation transformed from a prerecorded panoramic video based on the same virtual game camera parameters and the gameplay. The generation and superimposition of the foreground images and background videos are repeatedly performed to dynamically reflect the user actions within the virtual game environment. The superimposition process may also include any kind of synchronization process for the foreground images and the background images so that they are overlaid without any visual artifacts.

Thus, the present technology allows creating realistic game graphics with very high visual fidelity and detailed background graphical presentation, while providing freedom to the players to control the virtual game camera and the timing of user input. The import and transformation of pre-recorded video content do not require large computational resources compared to the resources required for real-time rendering of such scenes using traditional methods, and hence the present technology can be effectively employed in a number of game consoles, computers, mobile devices, and so forth.

According to one or more embodiments of the present disclosure, there is provided a method for compositing video game graphics, which includes the above steps. In further example embodiments, the method steps are stored on a machine-readable medium comprising instructions, which when implemented by one or more processors, perform the steps. In yet further example embodiments, hardware systems or devices can be adapted to perform the recited steps. Other features, examples, and embodiments are described below.

### BRIEF DESCRIPTION OF THE DRAWINGS

Embodiments are illustrated by way of example, and not by limitation in the figures of the accompanying drawings, in which like references indicate similar elements and in which:

FIG. 1 is an example layering structure used for compositing game graphics.

FIG. 2 shows an example result of superimposition of the layers presented in FIG. 1.

FIG. 3 shows a simplified representation of a spherical prerecorded panoramic video and how a particular part is captured by a virtual game camera.

FIG. 4 shows an example equirectangular projection of a spherical panoramic image.

FIG. 5 shows different examples of transformation of equirectangular projections to corresponding rectilinear projections.

FIG. 6 shows an example system environment suitable for implementing methods for compositing video game graphics.

FIG. 7 is a process flow diagram showing an example method for compositing video game graphics.

FIG. 8 is a diagrammatic representation of an example machine in the form of a computer system within which a set of instructions for the machine to perform any one or more of the methodologies discussed herein is executed.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is therefore not to be taken in a limiting sense, and the scope is defined by the appended claims and their equivalents. In this document, the terms “a” and “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

The techniques of the embodiments disclosed herein may be implemented using a variety of technologies. For example, the methods described herein may be implemented in software executing on a computer system or in hardware utilizing either a combination of microprocessors or other specially designed application-specific integrated circuits (ASICs), programmable logic devices, or various combinations thereof. In particular, the methods described herein may be implemented by a series of computer-executable instructions residing on a storage medium such as a disk drive, or computer-readable medium. It should be noted that methods disclosed herein can be implemented by a computer (e.g., a desktop computer, tablet computer, laptop computer), game console, handheld gaming device, cellular phone, smart phone, smart television system, and so forth.

In general, the embodiments of the present disclosure teach methods for creation of realistic and very high quality virtual environment graphics. A “virtual world” is an example of such virtual environment that is widely used in video and computer games. In virtual worlds, users can take the form of avatars, which are able to interact with other avatars or various game objects within the same virtual game environment. The ability for the users to explore the virtual world using input mechanisms, such as a game controller, is a basic requirement for interactive video games. In particular, the users can control the virtual game camera by manipulating the game controller to look around the virtual world and interactively perform various actions. When a user operates the virtual game camera, the technology described herein can be used to dynamically generate graphics of all that is captured by the virtual game camera and display on a user device.

Every game object used in the virtual world can be classified as interactive or non-interactive. Interactive game objects are those that could be affected by the actions of the player. Non-interactive game objects are those that the player cannot modify such as background elements including a sky, clouds, waterfalls, landscapes, nature scenes, and so forth. The technology, according to the embodiments of the present disclosure, uses pre-recorded video content to form some or all non-interactive game objects, while interactive game objects are rendered and then overlaid over the video content depending on the current position and parameters of the virtual game camera. The use of pre-recorded video content applied as a background can significantly reduce the need for computational resources and also increase the quality of game graphics. The pre-recorded video can be a real life video or a very high definition animation, and it may provide greater experience of enjoying playing the video game.

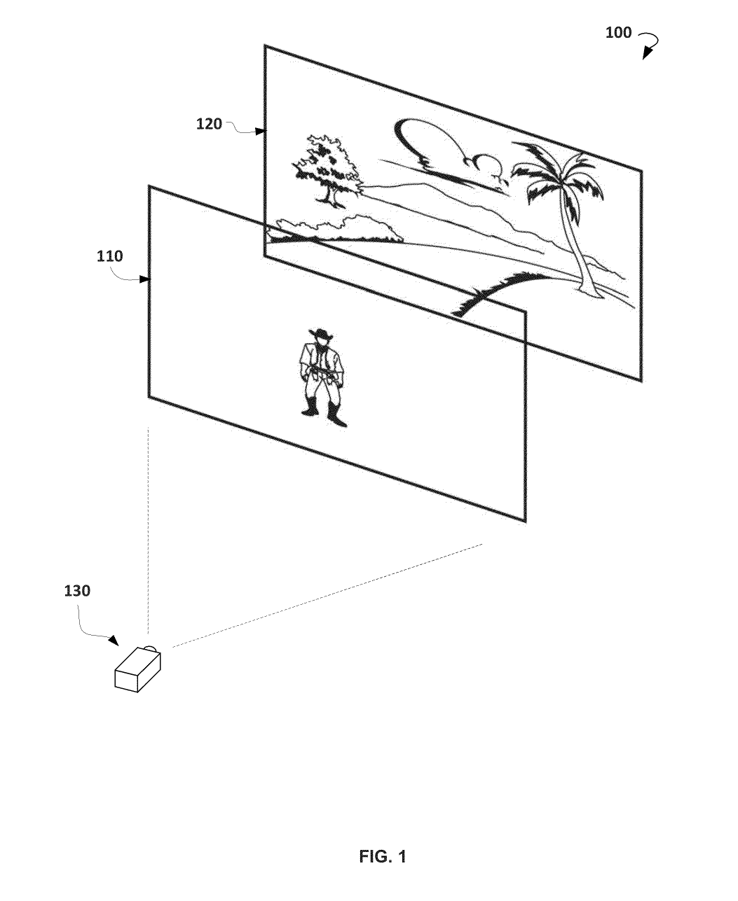

The principles described above are illustrated by FIG. 1, which is an example layering structure 100 used for compositing game graphics. In particular, there are shown a foreground layer 110, a background layer 120, and a virtual game camera 130. In an example embodiment, the foreground layer 110 and background layer 120 have a rectangular shape of the same size.

The foreground layer 110 can comprise images associated with interactive game objects, including an avatar that the player controls, other game characters, active game elements, and so forth. The images of interactive game objects can be dynamically rendered depending on the position and orientation of the virtual game camera 130. The rendering can be performed by a GPU or other rendering device so that the rendered images are either two- or three-dimensional. The images can be created in such a way they are placed on a transparent layer. In other words, there can be a number of opaque parts (pixels) of the layer 110 related to a particular interactive game object and also a number of transparent parts (pixels).

The background layer 120 can comprise pre-recorded video content or animation associated with non-interactive game elements including a sky, clouds, waterfalls, landscapes, nature scenes, city environments, and so forth. The video content can be two- or three-dimensional, and, moreover, it may also optionally include still images. As will be described below in greater details, the video content presented in the background layer 120 can be transformed from any kind of prerecorded panoramic video (e.g., spherical, cubical, or cylindrical prerecorded panoramic video) or its part by generating a corresponding equirectangular or rectilinear projections. The transformation and selection of a particular part of the prerecorded panoramic video are based on the current position, orientation, or other parameters of the virtual game camera 130. It should be also mentioned that the video content presented in the background layer 120 can be looped so that a certain video can be displayed repeatedly. The video content can be transformed or otherwise generated by a dedicated processor, such as a GPU or video decoder, or by a computing means, such as a central processing unit (CPU). The video content can reside in a machine readable medium or memory.

The term “virtual game camera,” as used herein, refers to a virtual system for capturing two-dimensional images of a three-dimensional virtual world. The virtual game camera 130 can be controlled by a user (i.e., a player) so that the images captured refer to the current position of the virtual game camera 130, its characteristics, position, and orientation. In the interactive games, such as first-person games, the game image is rendered from the viewpoint of the player character, which coincides with the view of the virtual game camera 130. In other words, the user sees the virtual world just like the avatar he controls. Accordingly, actions performed by the user will effect position of the virtual game camera 130, its orientation, and various parameters including a pan angle, a tilt angle, a roll angle, and zoom data.

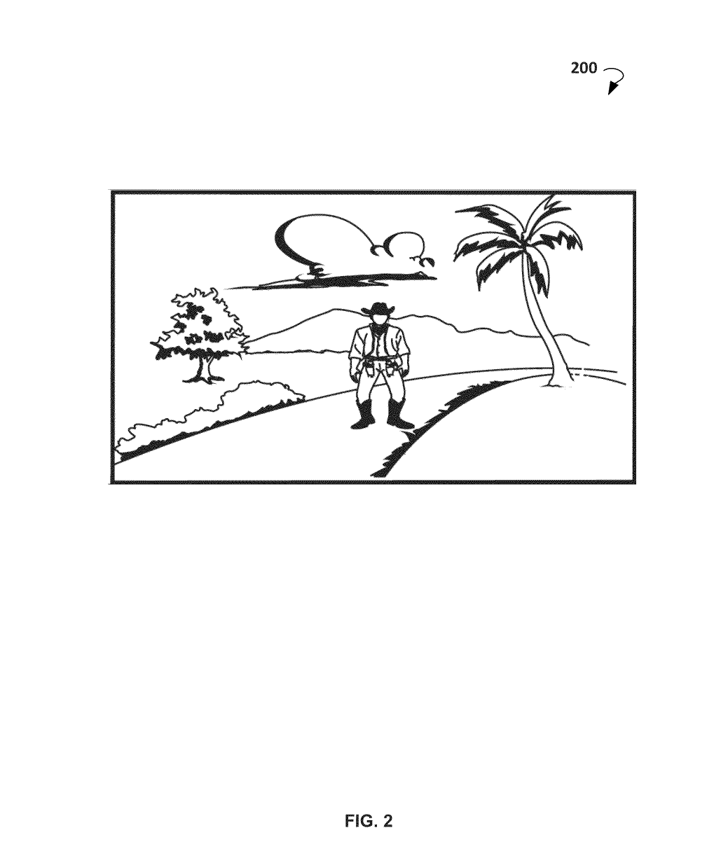

FIG. 2 shows an example result 200 of superimposition of the foreground layer 110 and the background layer 120 as captured by the virtual game camera 130 and displayed to a user. The superimposition can be performed dynamically and repeatedly (e.g., every 33 ms, or every frame of the video content). Accordingly, any move of the avatar and the virtual game camera 130 will immediately be reflected on a display screen. The superimposition process may also include any kind of synchronization process for the foreground layer 110 and the background layer 120 so that they are overlaid without any visual artifacts. In an example embodiment, the synchronization can be performed with the use a synchronization method using time stamp techniques such as vertical synchronization that can enforce a constant frame rate. If required, video frames corresponding to the background layer may be dropped or duplicated to ensure proper synchronization.

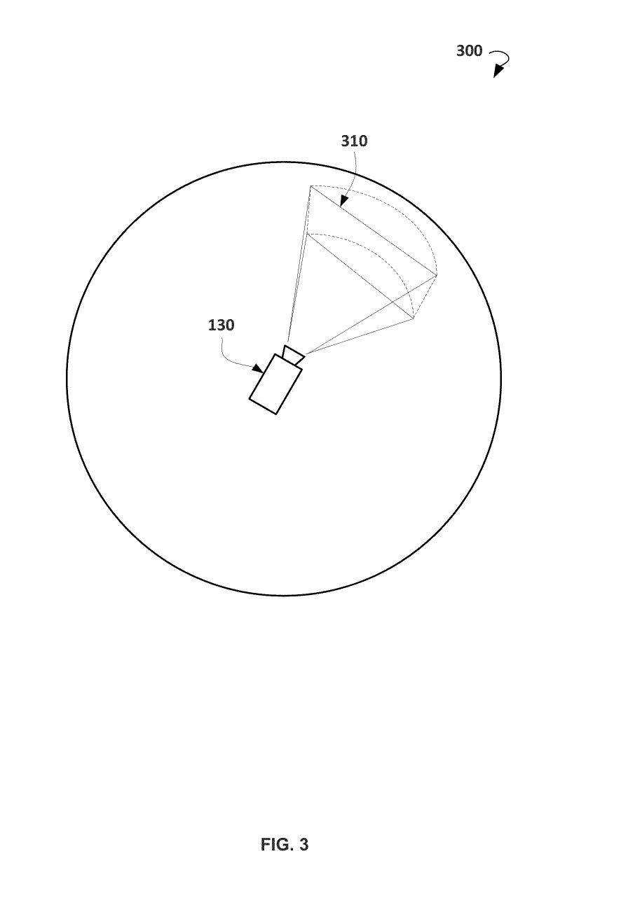

FIG. 3 shows a simplified representation of a spherical prerecorded panoramic video 300 and how a particular part of the spherical prerecorded panoramic video 300 is captured by the virtual game camera 130. The virtual game camera need not be stationary, and may move along a predetermined path. As shown in the figure, the virtual game camera 130 captures a specific part 310 of the spherical prerecorded panoramic video 300 depending on the position or orientation of the virtual game camera 130. The captured part 310 can be then be decompressed (or decoded) and transformed into a two-dimensional form suitable for displaying on a user device. For example, the spherical prerecorded panoramic video 300 can be transformed to exclude any distortions or visual artifacts as will be described below.

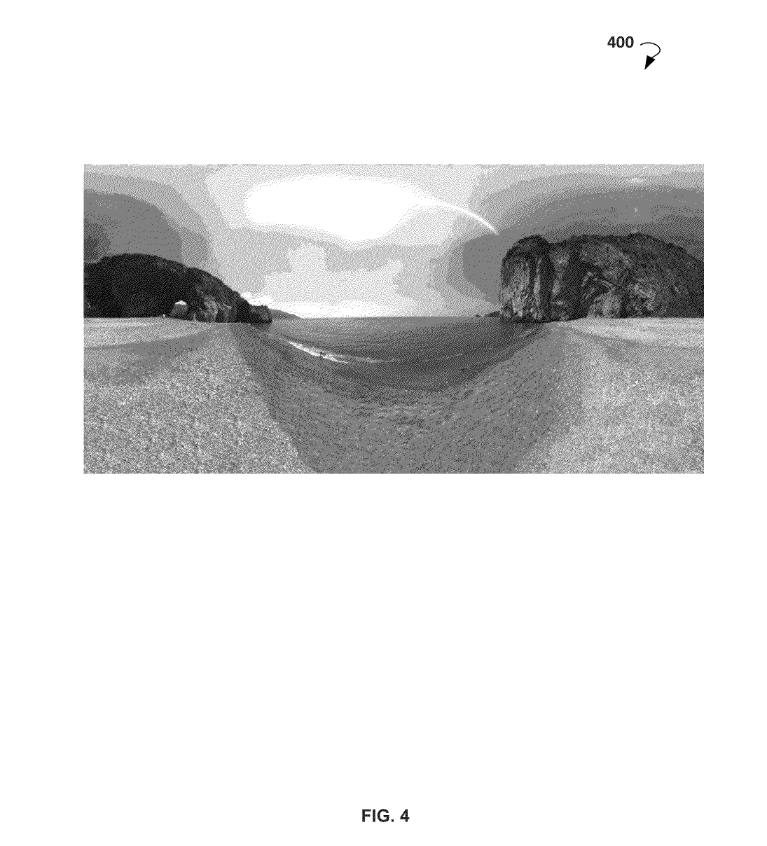

FIG. 4 shows an example equirectangular projection 400 of a spherical panoramic image (e.g., a frame of the prerecorded panoramic video). The example shown in FIG. 4 has a horizontal field of view of 360 degrees and a vertical field of view of 180 degrees. However, as it is described herein, only a portion of the projection 400 will be visible during gameplay, and this portion is determined by the position and orientation of the virtual game camera 130. The orientation of the virtual game camera 130 can be defined by such parameters as a pan angle, tilt angle, roll angle, and zoom data. The values of the pan angle, tilt angle, roll angle, and zoom can be set by a game developer, or the game developer can allow the player to control these values by controlling the avatar or using the game controller 650. Limits may also be set to the maximum and minimum values for each of these parameters. A personal reasonably skilled in the art would be able to convert the values of these parameters for the game camera to the respective parameters for the panoramic video content.

The prerecorded panoramic video content used as a background layer 120 can be captured using a surround video capturing camera system such as the Dodeca® 2360 from Immersive Media Company (IMC) or LadyBug® 3 from Point Grey Research, Inc. However, the prerecorded panoramic video can also be created from footage captured using multiple cameras, each capturing a different angle of the panorama. The background video can also be rendered by GPU or other rendering device in different viewing angles to cover the complete field of view, and then these different views can be combined together to form a single frame of the prerecorded panoramic video. The process of creating the background video using various computational resources need not be done in real time, and therefore could incorporate complex lighting and physics effects, animation, and other visual effects having a great importance for the players.

In various embodiments, the number of frames in the video depends on the amount of time the background non-interactive game objects need to be shown on a display screen and the frame rate of the video game. If the background video consists of a pattern that repeats, the video could be looped to reduce the number of frames that need to be stored. A looping background video could be used, for example, in racing games that take place in a racing circuit, or for games that feature waves on water surfaces, to name a few.

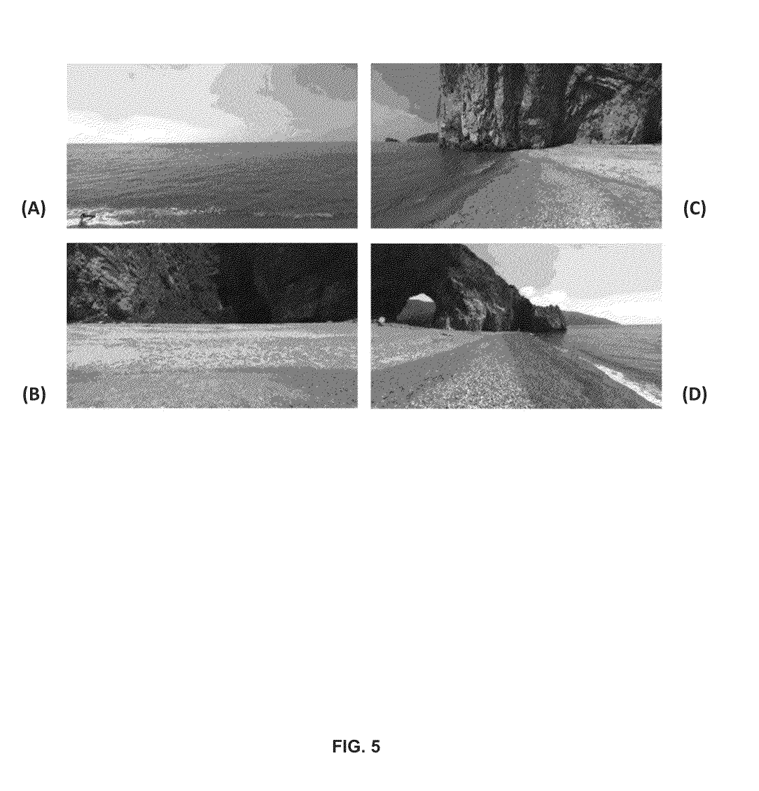

The section of the panorama that needs to be displayed based on the values of the control parameters can be transformed using a rectilinear projection to remove various visual distortions. FIG. 5 shows different examples of the transformation from the equirectangular projection 400 to corresponding rectilinear projections. The images on FIG. 5 correspond to tilt and roll angles of 0 degrees and different values of the pan angle.

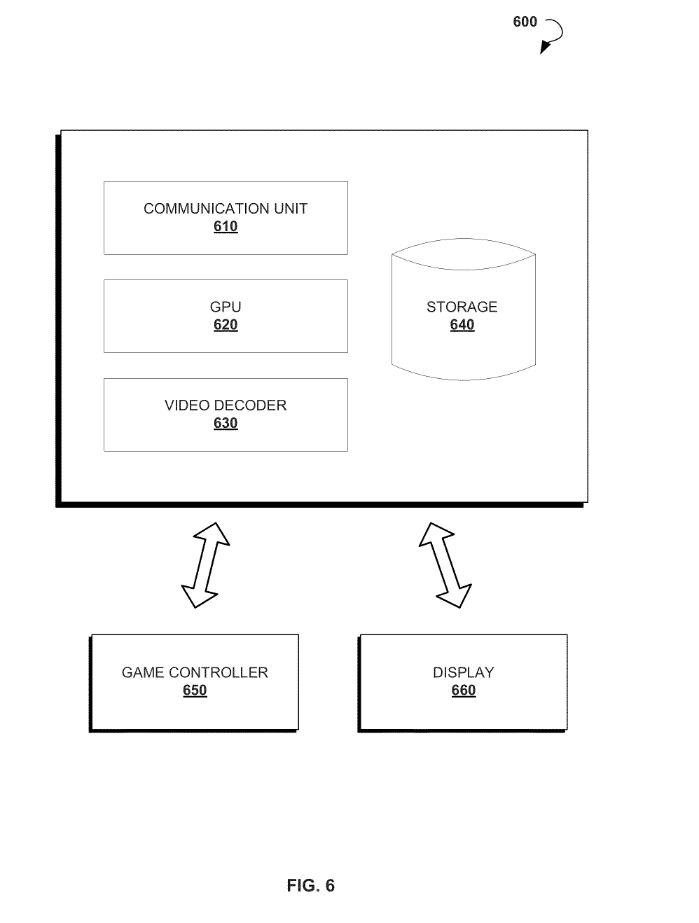

FIG. 6 shows an example system environment 600 for implementing methods for compositing video game graphics according to one or more embodiments of the present disclosure. In particular, system environment 600 may include a communication unit 610, a GPU 620, a video decoder 630, and storage 640. The system environment 600 can be operatively coupled to or include a game controller 650 and a display 660. As will be appreciated by those skilled in the art, the aforementioned units and devices may include hardware components, software components (i.e., virtual modules), or a combination thereof. Furthermore, processor-executable instructions can be associated with the aforementioned units and devices which, when executed by one or more of the said units, will provide functionality to implement the embodiments disclosed herein.

All or some units 610-660 can be integrated within a single apparatus, or, alternatively, can be remotely located and optionally accessed via a third party. The system 600 may further include additional units, such as CPU or High Definition Video Processor (HDVP), but the disclosure of such modules is omitted so as to not burden the entire description of the present teachings. In various additional embodiments, the functions of the disclosed herein units 610-660 can be performed by other devices (e.g., CPU, HDVP, etc.).

The communication unit 610 can be configured to provide communication between the GPU 620, the video decoder 630, the storage 640, the game controller 650, and the display 660. In particular, the communication unit 610 can receive user control commands, which can then be used to determine the current position and orientation of the virtual game camera 130. Furthermore, the communication unit 610 can also transmit data, such as superimposed foreground images and background videos, to the display 660 for displaying to the user. The communication unit 610 can also provide transmit data from and to the storage 640.

The GPU 620 can be configured, generally speaking, to process graphics. More specifically, the GPU 620 is responsible for rendering images of the foreground layer 110 based on game data, the current gameplay, the current position and orientation of the virtual game camera 130, user commands, and so forth. The GPU can also superimpose the images of the foreground layer 110 and the video content of the background layer 120 to provide the resulting image to be transformed to the display 660 for presenting to the user.

In order to perfectly match the background layer 120 with the foreground layer 110, one or more synchronization methods can be also implemented by the GPU 620 using either time stamps or techniques such as vertical synchronization that can enforce a constant frame rate.

The video decoder 630 can be configured to process video content. More specifically, the video decoder 630 can be responsible for decoding or compressing video content and also for transformation of prerecorded panoramic video content from equirectangular projections to corresponding rectilinear projections based on game data, predetermined settings, the current gameplay, the current position and orientation of the virtual game camera 130, user commands, and so forth. This transformation may also be performed using the GPU as mentioned above with reference to FIG. 1.

When the video decoder 630 decompresses the pre-recorded video data, any distortions will be avoided. For example, if the width of the final composited frame that is displayed is w, the width of the equirectangular projection shall be at least 3 w. The height of the equirectangular projections shall be at least 3w/2. However, for a limited horizontal or vertical field of view, the width and the height of the displayable frame can be smaller than 3 w and 3w/2, respectively. Any compression standard could be used that allows high speed decoding of the video frames at this resolution.

The storage 640 can be configured to store game data needed for running a video game, data necessary for generating the foreground layer 110 images, and pre-recorded videos for the background layer 120. The pre-recorded video can be adaptively selected based on the current gameplay (e.g., there can be the same scenes for day and night). The storage 640 may also store various processor-executable instructions.

The game controller 650 can be configured to provide input to a video game (typically to control an avatar, a game object or character in the video game). The game controller 650 can include keyboards, mice, game pads, joysticks, and so forth.

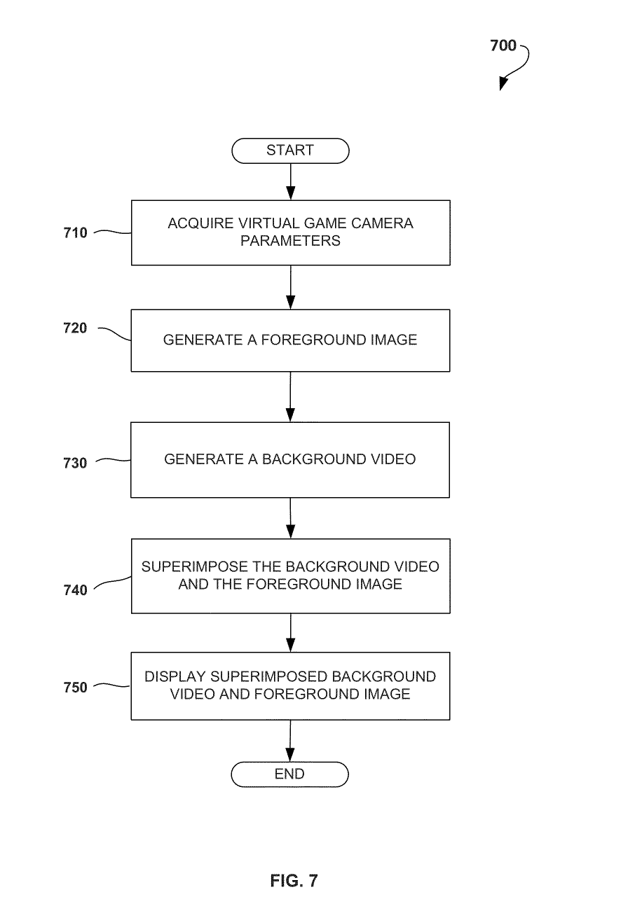

FIG. 7 is a process flow diagram showing a method 700 for compositing video game graphics, according to an example embodiment. The method 700 may be performed by processing logic that may comprise hardware (e.g., dedicated logic, programmable logic, and microcode), software (such as software run on a general-purpose computer system or a dedicated machine), or a combination of both. In one example embodiment, the processing logic resides at the system 600. In other words, the method 700 can be performed by various units discussed above with reference to FIG. 6.

As shown in FIG. 7, the method 700 may commence at operation 710, with the communication unit 610 acquiring parameters of the virtual game camera 130. The parameters of the virtual game camera 130 include one or more of a pan angle, a tilt angle, a roll angle, zoom data, and current position.

At operation 720, the GPU 620 generates a foreground image, which is associated with one or more interactive game objects. The foreground image may be generated based on the parameters of the virtual game camera 130. The foreground images include both opaque and transparent parts (pixels). In various embodiments, the GPU 620 can generate multiple foreground images.

At operation 730, the video decoder 630 generates a background video by selecting and transforming at least a part of virtual prerecorded panoramic video from an equirectangular projection to a corresponding rectilinear projection. This transformation may also be performed using the GPU as mentioned above with reference to FIG. 1. The selection and transformation of the prerecorded panoramic video may be performed in accordance with current parameters of the virtual game camera 130. The process of generation of the background video may further include decompression or decoding of the video data and post-processing such as adding blurring effects and color transformation, which is not computationally intensive.

At operation 740, the GPU 620 superimposes the background video and the foreground image(s). The superimposition process may include synchronization of the background video and the foreground image(s) to exclude visual artifacts.

At operation 750, the GPU 620 displays superimposed the background video and the foreground image through the display 660.

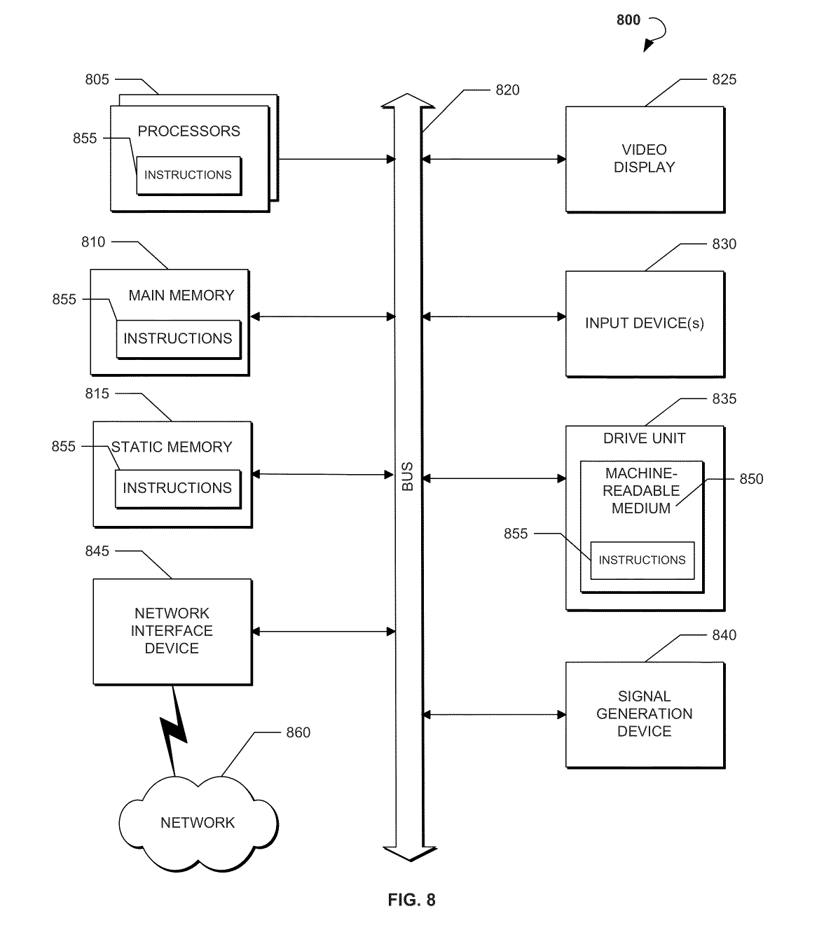

FIG. 8 shows a diagrammatic representation of a computing device for a machine in the example electronic form of a computer system 800, within which a set of instructions for causing the machine to perform any one or more of the methodologies discussed herein can be executed. In example embodiments, the machine operates as a standalone device, or can be connected (e.g., networked) to other machines. In a networked deployment, the machine can operate in the capacity of a server, a client machine in a server-client network environment, or as a peer machine in a peer-to-peer (or distributed) network environment. The machine can be a personal computer (PC), tablet PC, set-top box (STB), PDA, cellular telephone, portable music player (e.g., a portable hard drive audio device, such as a Moving Picture Experts Group Audio Layer 3 (MP3) player), web appliance, network router, switch, bridge, or any machine capable of executing a set of instructions (sequential or otherwise) that specify actions to be taken by that machine. Further, while only a single machine is illustrated, the term “machine” shall also be taken to include any collection of machines that separately or jointly execute a set (or multiple sets) of instructions to perform any one or more of the methodologies discussed herein.

The example computer system 800 includes a processor or multiple processors 805 (e.g., a CPU, a GPU, or both), and a main memory 810 and a static memory 815, which communicate with each other via a bus 820. The computer system 800 can further include a video display unit 825 (e.g., a LCD or a cathode ray tube (CRT)). The computer system 800 also includes at least one input device 830, such as an alphanumeric input device (e.g., a keyboard), a cursor control device (e.g., a mouse), a microphone, a digital camera, a video camera, and so forth. The computer system 800 also includes a disk drive unit 835, a signal generation device 840 (e.g., a speaker), and a network interface device 845.

The disk drive unit 835 includes a computer-readable medium 850, which stores one or more sets of instructions and data structures (e.g., instructions 855) embodying or utilized by any one or more of the methodologies or functions described herein. The instructions 855 can also reside, completely or at least partially, within the main memory 810 and/or within the processors 805 during execution thereof by the computer system 800. The main memory 810 and the processors 805 also constitute machine-readable media.

The instructions 855 can further be transmitted or received over the communications network 860 via the network interface device 845 utilizing any one of a number of well-known transfer protocols (e.g., Hyper Text Transfer Protocol (HTTP), CAN, Serial, and Modbus).

While the computer-readable medium 850 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, flash memory cards, digital video disks, random access memory (RAM), read only memory (ROM), and the like.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written in any number of suitable programming languages such as, for example, Hypertext Markup Language (HTML), Dynamic HTML, XML, Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™ Jini™ C, C++, C#, .NET, Adobe Flash, Perl, UNIX Shell, Visual Basic or Visual Basic Script, Virtual Reality Markup Language (VRML), ColdFusion™ or other compilers, assemblers, interpreters, or other computer languages or platforms.

Thus, methods and systems for compositing video game graphics are disclosed. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A computer-implemented method for compositing video game graphics, the method comprising:
generating one or more foreground images associated with one or more interactive game objects;
generating a background video associated with one or more non-interactive game objects, wherein the background video is generated by transforming at least a part of one or more prerecorded panoramic videos; and
superimposing the background video and the foreground image.

2. The computer-implemented method of claim 1, further comprising acquiring parameters associated with a virtual game camera, the parameters comprising one or more of a pan angle, a tilt angle, a roll angle, zoom data, and a virtual game camera position.

3. The computer-implemented method of claim 2, wherein the background video is generated based on the parameters associated with the virtual game camera.

4. The computer-implemented method of claim 2, further comprising selecting the at least a part of the one or more prerecorded panoramic videos based on the parameters associated with the virtual game camera.

5. The computer-implemented method of claim 1, wherein generating the background video comprises generating a rectilinear projection of the at least a part of the prerecorded panoramic video.

6. The computer-implemented method of claim 1, wherein the one or more background videos comprise one or more equirectangular projections of the at least a part of the one or more prerecorded panoramic videos.

7. The computer-implemented method of claim 1, wherein the one or more prerecorded panoramic videos include a spherical prerecorded panoramic video.

8. The computer-implemented method of claim 1, wherein the one or more prerecorded panoramic videos include a cubical prerecorded panoramic video.

9. The computer-implemented method of claim 1, wherein the one or more prerecorded panoramic videos include a cylindrical prerecorded panoramic video.

10. The computer-implemented method of claim 1, wherein the one or more prerecorded panoramic videos include a real life prerecorded panoramic video.

11. The computer-implemented method of claim 1, wherein the one or more prerecorded panoramic videos include a panoramic animation.

12. The computer-implemented method of claim 1, wherein the one or more prerecorded panoramic videos are looped prerecorded panoramic videos.

13. The computer-implemented method of claim 1, wherein generating the background video comprises performing one or more post-processing techniques to a prerecorded panoramic video.

14. The computer-implemented method of claim 1, wherein generating the background video comprises decompressing or decoding a prerecorded panoramic video.

15. The computer-implemented method of claim 1, wherein generating the one or more foreground images comprises rendering one or more three-dimensional interactive game object images.

16. The computer-implemented method of claim 1, wherein the one or more foreground images include one or more transparent parts and one or more opaque parts.

17. The computer-implemented method of claim 1, wherein superimposing comprises synchronizing the background video and the one or more foreground images.

18. The computer-implemented method of claim 1, further comprising dynamically selecting the prerecorded panoramic video based on a current gameplay.

19. The computer-implemented method of claim 1, further comprising displaying superimposed the background video and the one or more foreground image.

20. A system for compositing video game graphics, the system comprising:
a graphics processing unit configured to generate one or more foreground images being associated with one or more interactive game objects;
a video decoder configured to generate a background video associated with one or more non-interactive game objects, wherein the background video is generated by transforming at least a part of one or more prerecorded panoramic videos; and
wherein the graphics processing unit is further configured to superimpose the background video and the foreground image.

21. A non-transitory processor-readable medium having embodied thereon instructions being executable by at least one processor to perform a method for compositing video game graphics, the method comprising:
generating one or more foreground images associated with one or more interactive game objects;
generating a background video associated with one or more non-interactive game objects, wherein the background video is generated by transforming at least a part of one or more prerecorded panoramic videos; and
superimposing the background video and the foreground image.
